(19) United States
(12) Patent Application Publication
(10) Pub. No.: US 2025/0299870 A1
(43) Pub. Date: Sep. 25, 2025

(54) INDUCTOR AND METHOD FOR MANUFACTURING INDUCTOR

(71) Applicant: Panasonic Intellectual Property Management Co., Ltd., Osaka (JP)

(72) Inventors: Tomohiro SUGIMURA, Osaka (JP); Yuya ISHIDA, Shiga (JP); Takumi TANIKAWA, Hyogo (JP); Koichi YAMADA, Fukui (JP); Tomohiro TSUBOTA, Fukui (JP); Yuta MIYASAKA, Kanagawa (JP); Naoya HONDA, Osaka (JP); Shinji FUJIMOTO, Hyogo (JP)

(73) Assignee: Panasonic Intellectual Property Management Co., Ltd., Osaka (JP)

(21) Appl. No.: 18/862,268

(22) PCT Filed: May 10, 2023
(86) PCT No.: PCT/JP2023/017526

§ 371 Date: Nov. 1, 2024

(30) Foreign Application Priority Data
May 12, 2022 (JP) 2022-078525
Nov. 29, 2022 (JP) 2022-190598
Nov. 29, 2022 (JP) 2022-190599
Nov. 29, 2022 (JP) 2022-190600

(51) Int. Cl. H01F 27/28; H01F 27/255; H01F 41/02; H01F 41/10

(52) U.S. Cl. CPC H01F 27/2828; H01F 27/255; H01F 41/0246; H01F 41/10

(57) ABSTRACT

An inductor includes: a magnetic core provided by pressure molding a mixture of a magnetic material powder and a binder; a coil element embedded in the magnetic core; and an electrode member electromechanically connected to an end portion of the coil element. The end portion of the coil element is placed on the electrode member provided on an end surface of the magnetic core, and connected at a crimp portion. The crimp portion is embedded in the magnetic core. At least a portion of an end surface portion of the electrode member at the end surface of the magnetic core is embedded in and fixed to the magnetic core in a thickness direction of the electrode member. A bottom surface portion of the electrode member at a bottom surface of the magnetic core is not fixed to the magnetic core.

### TECHNICAL FIELD

The present invention relates to an inductor that can be used in various types of electronic equipment, and a method for manufacturing the inductor.

### BACKGROUND ART

Along with an increased performance of electronic equipment in recent years, the demand for size reduction of electronic equipment is increasing, and the required amount of electric current tends to increase. Accordingly, there is a need for inductors that satisfy these requirements. Furthermore, inductors for use in harsh environments such as in-vehicle inductors are also required to have vibration resistance and heat cycle resistance. For this reason, an inductor whose magnetic core is formed by embedding a coil element in a mixed powder of a metal magnetic material powder and a thermosetting resin binder, and pressure molding the whole is proposed.

Also, in order to reduce the cost for forming an external electrode, it is also proposed to mold an external electrode-forming member at the same time when a magnetic core is formed.

As related art document information related to the invention of the present application, for example, Patent Literatures (PTLs) 1 and 2 are known.

### CITATION LIST

### Patent Literatures

### [PTL 1]

Japanese Unexamined Patent Application Publication No. 2012-230972

### [PTL 2]

Japanese Unexamined Patent Application Publication No. 2005-294461

### SUMMARY OF INVENTION

### Technical Problem

However, inductors for use in harsh environments such as in-vehicle inductors are required to have vibration resistance and heat cycle resistance.

It is an object of the present invention to provide a small-sized inductor that can be used in high power applications and has excellent vibration resistance and excellent heat cycle resistance, and the like.

### Solution to Problem

An inductor according to an aspect of the present invention includes: a magnetic core including a bottom surface and an end surface connected to the bottom surface, the magnetic core being provided by pressure molding a mixture of a magnetic material powder and a binder; a coil element embedded in the magnetic core; and an electrode member electromechanically connected to an end portion of the coil element, wherein the electrode member is bent toward the bottom surface of the magnetic core from the end surface of the magnetic core, the electrode member includes a crimp portion, the electrode member and the end portion of the coil element being electromechanically connected by placing the end portion of the coil element on the electrode member, and crimping and welding the end portion of the coil element to the electrode member at the crimp portion, the crimp portion is embedded in the magnetic core, at least a portion of the electrode member at the end surface of the magnetic core is embedded in and fixed to the magnetic core in a thickness direction of the electrode member, and a portion of the electrode member at the bottom surface of the magnetic core is not fixed to the magnetic core.

A method for manufacturing an inductor according to an aspect of the present invention is a method for manufacturing an inductor in which a coil element is embedded in a magnetic core including a bottom surface and an end surface connected to the bottom surface, and end portions of the coil element are electromechanically connected to electrode members, the method including: forming the coil element by spirally winding a conductor wire whose surface is covered with an insulation covering, pulling out opposing ends of the conductor wire in opposite directions, and stripping the insulation covering at the opposing ends of the conductor wire; providing the electrode members each including a crimp portion, an end surface portion, a bottom surface portion, and a support portion; crimping the end portions of the coil element to the electrode members at the crimp portions by placing the end portions of the coil elements on the electrode members, respectively, to fix the end portions of the coil element to the electrode members; welding the coil element and the electrode members together to form an integrated body of the coil element and the electrode members by irradiating the crimp portions with laser light; bending the end portions of the coil element or the electrode members; obtaining an upper magnetic powder tablet and a lower magnetic powder tablet by molding a mixture of a magnetic material powder and a resin; forming the magnetic core by pressure molding the upper magnetic powder tablet, the integrated body of the coil element and the electrode members, and the lower magnetic powder tablet that have been placed in a die in stated order; and forming an electrode by cutting off the support portion of each of the electrode members and folding the bottom surface portion of the electrode member, wherein the crimp portions are embedded in the magnetic core, at least a portion of each of the electrode members at the end surface of the magnetic core is embedded in and fixed to the magnetic core in a thickness direction of the electrode member, and a portion of each of the electrode members at the bottom surface of the magnetic core is not fixed to the magnetic core.

### Advantageous Effects of Invention

With the configurations described above, it is possible to provide an inductor that has excellent vibration resistance and excellent heat cycle resistance, and the like.

### BRIEF DESCRIPTION OF DRAWINGS

FIG. 1 is a transparent perspective view of an inductor according to one embodiment of the present invention.

FIG. 2 is a cross-sectional view of the inductor according to the embodiment of the present invention.

FIG. 3 is a flowchart of a method for manufacturing an inductor according to one embodiment of the present invention.

FIG. 4 is a diagram illustrating a part of the method for manufacturing an inductor according to the embodiment of the present invention.

FIG. 5 is a transparent perspective view of an inductor according to another aspect of the embodiment of the present invention.

FIG. 6 is a partial perspective view of the inductor shown in FIG. 5.

FIG. 7 is a diagram illustrating a part of a method for manufacturing an inductor according to another aspect of the embodiment of the present invention.

FIG. 8 is a diagram illustrating a part of the method for manufacturing an inductor according to the embodiment of the present invention.

FIG. 9 is a diagram illustrating a part of the method for manufacturing an inductor according to the embodiment of the present invention.

FIG. 10 is a diagram illustrating a part of the method for manufacturing an inductor according to the embodiment of the present invention.

### DESCRIPTION OF EMBODIMENTS

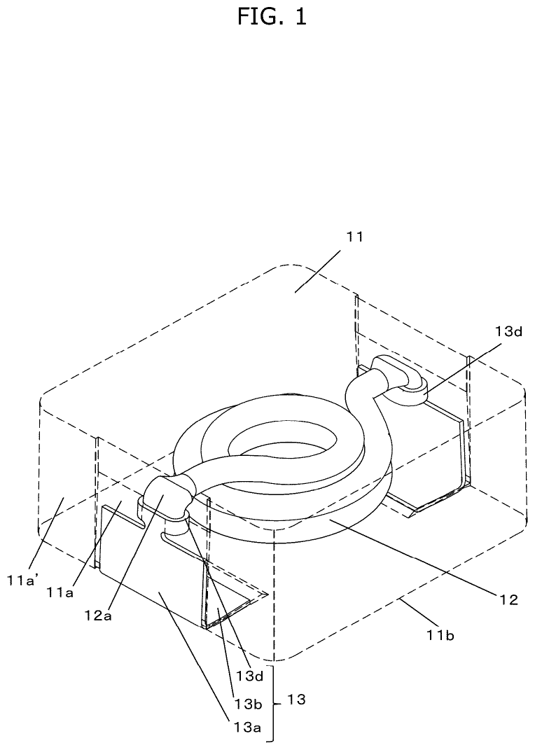

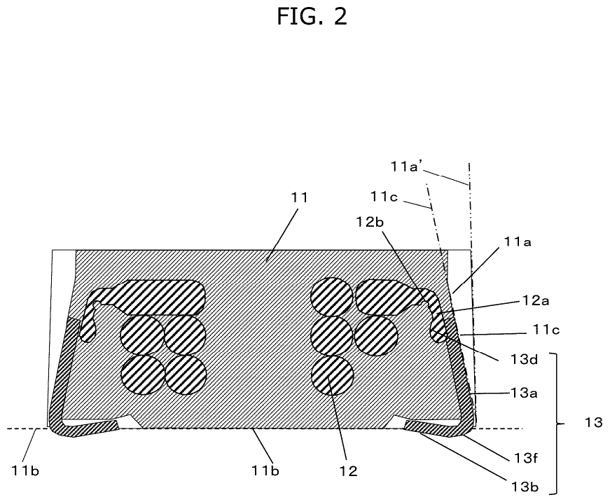

Hereinafter, an inductor according to one embodiment of the present invention will be described with reference to the drawings. FIG. 1 is a transparent perspective view of the inductor according to the embodiment of the present invention, and FIG. 2 is a cross-sectional view of the inductor. In FIG. 1, for the sake of clarity of the drawing, the outer shape of the magnetic core is indicated by a broken line. FIG. 2 shows a cross section of the inductor taken along a plane that passes through opposing ends of the coil element and is perpendicular to the bottom surface of the magnetic core.

Coil element 12 is a coil element formed by winding an insulation covering conductor wire with a diameter of about 0.3 mm, and each coil element end portion 12a is formed by stripping the insulation covering from the conductor wire and flattening the stripped portion into a flat shape with a thickness of about 0.2 mm. Magnetic core 11 is formed by embedding coil element 12 in a magnetic material powder prepared by mixing a magnetic material powder made of an Fe—Si—Cr alloy and a binder made of a silicone, and then pressure molding the whole. Magnetic core 11 is a rectangular parallelepiped, with a square planar shape of about 10 mm and a height of about 5 mm, and includes magnetic core bottom surface 11b and magnetic core end surface 11a connected to magnetic core bottom surface 11b. Electrode members 13 are fixed to magnetic core end surface 11a, and folded along magnetic core bottom surface 11b. Each electrode member 13 includes end surface portion 13a and bottom surface portion 13b.

At least a portion of electrode member 13 at magnetic core end surface 11a is embedded in and fixed to magnetic core 11 in a thickness direction of electrode member 13, and a portion of electrode member 13 at magnetic core bottom surface 11b is not fixed to magnetic core 11. Each electrode member 13 includes crimp portion 13d at a leading end of end surface portion 13a. Coil element end portion 12a and electrode member 13 are crimped by placing coil element end portion 12a on electrode member 13 and folding crimp portion 13d to press attach crimp portion 13d to coil element end portion 12a. By welding crimp portion 13d to coil element end portion 12a, crimp portion 13d and coil element end portion 12a are electromechanically connected. Crimp portion 13d is embedded in magnetic core 11 so as to extend in the center direction of magnetic core 11. By embedding the crimped and welded portion in magnetic core 11, electrode member 13 is unlikely to be detached from magnetic core 11. Accordingly, reliability can be improved.

Also, notch 12b is formed in coil element end portion 12a between a wound portion of coil element 12 and crimp portion 13d, and coil element end portion 12a is bent at notch 12b. When the folded portion moves in the embedded region in the magnetic core, the shape of the coil element is also likely to be deformed. As a result, electric characteristics such as inductance value are likely to vary. To address this, notch 12b is formed in coil element end portion 12a. With this configuration, coil element end portion 12a can be bent at notch 12b, and the shape of the coil element can be stabilized, as a result of which, the electric characteristics can be stabilized. In an ordinary inductor, a notch is provided to make coil element end portion 12a bendable. However, forming a notch is likely to deteriorate mechanical strength. In contrast, in the inductor according to the present embodiment, the bent portion bent at notch 12b is embedded in and fixed to magnetic core 11. Accordingly, even when notch 12b is formed, the mechanical strength can be maintained.

Electrode member 13 is obtained by punching a flat copper plate made of 99% or more copper, and has a thickness of about 0.15 mm. On one surface of electrode member 13, plating layer 13f plated with nickel and tin in stated order is provided. On the other surface of electrode member 13, copper is exposed. A surface of electrode member 13 at magnetic core end surface 11a on which no plating layer is provided faces magnetic core 11. On the other hand, on a surface of electrode member 13 opposite to the surface of electrode member 13 that faces magnetic core 11, plating layer 13f is provided. Accordingly, the inductor can be easily soldered to a mounting board. Also, no plating layer is provided on the surface of electrode member 13 that faces magnetic core 11, and thus even in a high temperature environment such as solder reflow, the bonding strength between magnetic core 11 and electrode member 13 can be maintained.

Furthermore, electrode member 13 at magnetic core end surface 11a is embedded in and fixed to magnetic core 11, and thus the vibration resistance can be improved. On the other hand, electrode member 13 at magnetic core bottom surface 11b is not fixed to magnetic core 11, and thus even if the thermal expansion coefficients of the mounting board and the inductor are different, the influence of expansion caused by heat cycle can be mitigated, and thus the heat cycle resistance can be improved.

An angle formed by magnetic core bottom surface 11b (indicated by a broken extension line in FIG. 2) and surface 11c (indicated by a dash-dotted line in FIG. 2) of the end surface portion of the electrode member at magnetic core end surface 11a is set to about 86.5°. Also, an angle formed by magnetic core bottom surface 11b and magnetic core end surface 11a′ on opposing sides of electrode member 13 (indicated by a dash-double dotted extension line in FIG. 2) is set to about 89.5°. Here, the reference surface of magnetic core bottom surface 11b refers to a surface of magnetic core bottom surface 11b when it is placed on a flat plate, with electrode member 13 at magnetic core bottom surface 11b being removed. The reason that the angle formed by magnetic core bottom surface 11b and magnetic core end surface 11a′ on opposing sides of electrode member 13 is set to about 89.5°, which is less than 90.0°, is to make a slight incline such that magnetic core 11 can be easily removed from the die after pressure molding. As used herein, the term “incline” refers to a slope relative to a line extending in the pressing direction during pressure molding, or in other words, a slope relative to a line perpendicular to magnetic core bottom surface 11b.

In the case where the magnetic core is formed through pressure molding using a die, the entire magnetic core tends to expand when the magnetic core is removed from the die. Accordingly, the electrode members at the end surfaces of the magnetic core are also pressed by the wall of the die with a strong stress, and thus may be damaged. In contrast, in one embodiment of the present invention, the angle formed by magnetic core bottom surface 11b and magnetic core end surface 11a′ on opposing sides of electrode member 13 at magnetic core end surface 11a is closer to the right angle than the angle formed by magnetic core bottom surface 11b and end surface portion 13a of the electrode member is. Accordingly, even if entire magnetic core 11 expands, magnetic core end surface 11a′ on opposing sides of electrode member 13 at magnetic core end surface 11a functions as a support to restrict the expansion of surface 11c at the end surface portion of the electrode member. For this reason, end surface portion 13a of electrode member 13 at magnetic core end surface 11a is unlikely to be damaged. Here, end surface portion 13a of electrode member 13 is inclined at an angle steeper than magnetic core end surface 11a′ on opposing sides of electrode member 13, and thus the pressure exerted toward magnetic core end surface 11a during pressure molding is dispersed in the incline direction, and it is therefore possible to restrict the expansion of entire magnetic core 11.

It is desirable that an angle formed by surface 11c at the end surface portion of the electrode member at magnetic core end surface 11a and magnetic core end surface 11a′ on opposing sides of electrode member 13 is set to 2.0° or more and 5.0° or less. When the angle is less than 2.0°, the effect of suppressing damage to electrode member 13 is small. When the angle is greater than 5.0°, magnetic core 11 is likely to crack during the process of bending electrode member 13 from magnetic core end surface 11a toward magnetic core bottom surface 11b, and it is therefore not desirable to set the angle to be greater than 5.0°.

Also, end surface portions 13a of electrode members 13 are forward-tapered with respect to the mounting surface, and thus solder can be easily wetted when the inductor is mounted on the mounting surface and soldered. With this configuration, it is possible to provide an inductor with excellent solderability. Also, because end surface portions 13a of electrode members 13 are forward-tapered with respect to the mounting surface, the state of solder can be easily checked from above.

Next, a method for manufacturing an inductor according to one embodiment of the present invention will be described.

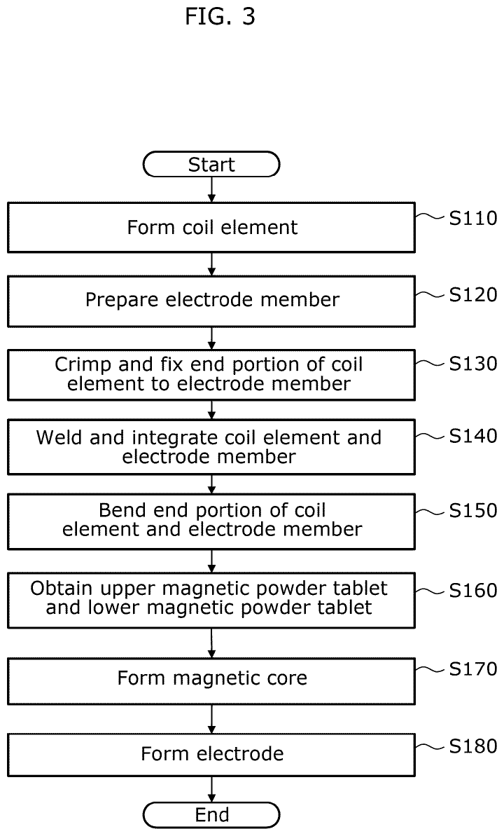

FIG. 3 is a flowchart of the method for manufacturing an inductor according to the embodiment of the present invention. As shown in FIG. 3, the method for manufacturing an inductor includes: step S110 of forming a coil element; step S115 of forming a notch in each end portion of the coil element; step S120 of preparing electrode members; step S130 of crimping and fixing each end portion of the coil element to a corresponding one of the electrode members; step S140 of welding and integrating the coil element and the electrode members; step S150 of bending the end portions of the coil element or the electrode members; step S160 of obtaining an upper magnetic powder tablet and a lower magnetic powder tablet; magnetic core forming step S170; and electrode forming step S180.

There is no particular limitation on the order in which steps S110, S120, and S160 are performed. Step S115 may be performed at the same time when step S110 is performed. Step S115 is only required to be performed prior to step S150. Step S160 may be performed prior to step S130. Hereinafter, the steps will be described one by one.

First, coil element 12 is formed by spirally winding a conductor wire whose surface is covered with an insulation covering and pulling out opposing ends of coil element 12 in opposite directions. As the conductor wire, an insulated copper wire with a diameter of about 0.3 mm is used, and each coil element end portion 12a is formed by stripping the insulation covering and flattening the stripped portion into a flat shape with a thickness of about 0.2 mm.

Meanwhile, electrode members 13 are obtained by punching out a flat plate that is composed of a copper plate made of 99% or more copper and has plating layer 13f plated with nickel and tin in stated order on one surface of the copper plate. Each electrode member 13 is an integrated body including: end surface portion 13a, which is a portion that is placed on magnetic core end surface 11a and is connected to coil element end portion 12a; bottom surface portion 13b, which is a portion that is continuous with end surface portion 13a and is placed on magnetic core bottom surface 11b; and support portion 13c, which is a portion that is continuous with bottom surface portion 13b on the side opposite to end surface portion 13a and is supported by the die when magnetic core 11 is pressure molded. Each electrode member 13 has a thickness of about 0.15 mm.

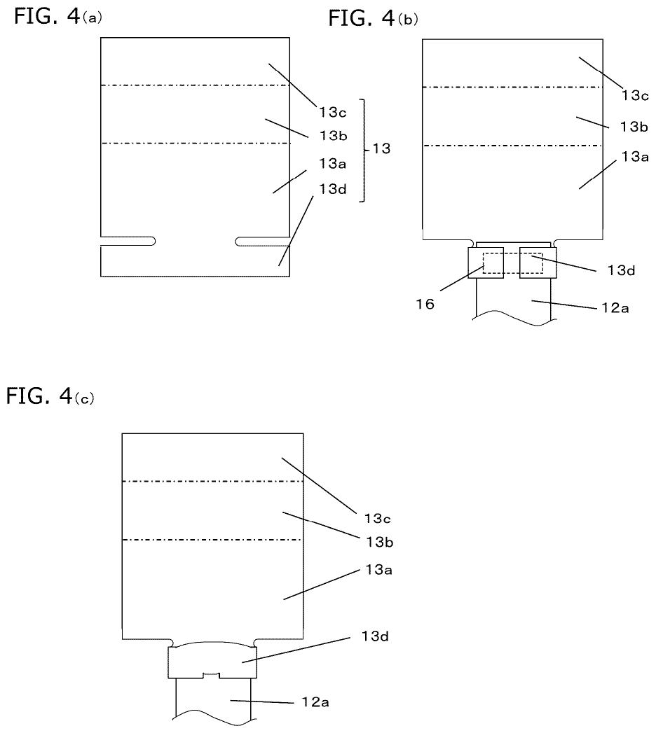

FIG. 4 is a diagram illustrating a part of the method for manufacturing an inductor according to the embodiment of the present invention.

In FIG. 4, (a) shows a plan view of electrode member 13. Electrode member 13 includes support portion 13c, bottom surface portion 13b, and end surface portion 13a that are linearly continuous, and also includes crimp portion 13d at an end of end surface portion 13a that is opposite to bottom surface portion 13b. As shown in (b) in FIG. 4, coil element end portion 12a is placed on crimp portion 13d, and crimp portion 13d is folded back to crimp to coil element end portion 12a in an overlapping manner. Coil element end portion 12a is thereby temporarily fixed to electrode member 13. At this time, a leading end of coil element end portion 12a is crimped to electrode member 13 to overlap electrode member 13, with the leading end of coil element end portion 12a protruding from crimp portion 13d. That is, the leading end of coil element end portion 12a is protruding from crimp portion 13d. Here, crimp portion 13d has a length of about 1.0 mm, and the leading end of coil element end portion 12a has a length protruding from crimp portion 13d of about 0.3 mm. As used herein, the term “length” refers to a length in the extension direction of coil element end portion 12a.

Next, the crimp portion formed by folding crimp portion 13d to overlap coil element end portion 12a, or in other words, laser light irradiation position 16 indicated by a broken line in (b) in FIG. 4 is irradiated with laser light from coil element 12 side toward the leading end of coil element end portion 12a while scanning across coil element end portion 12a in a zigzag manner in the extension direction of coil element end portion 12a so as to weld electrode member 13 and coil element end portion 12a. In this way, a state as shown in (c) in FIG. 4 is obtained. At this time, the leading end of coil element end portion 12a is not irradiated with laser light, but heat generated by the laser light irradiation is transferred to the leading end of coil element end portion 12a to melt and solidify the leading end, and thus the leading end of coil element end portion 12a has a rounded edge. Crimp portion 13d may take the following states including: a state before crimping; a state after crimping; and a melted and solidified state.

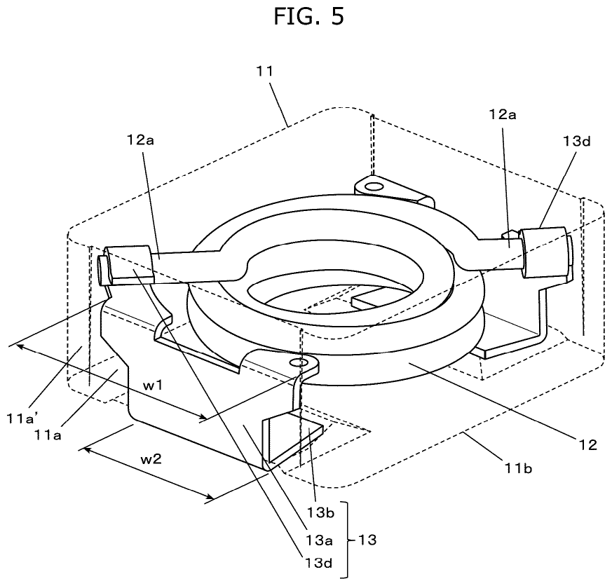

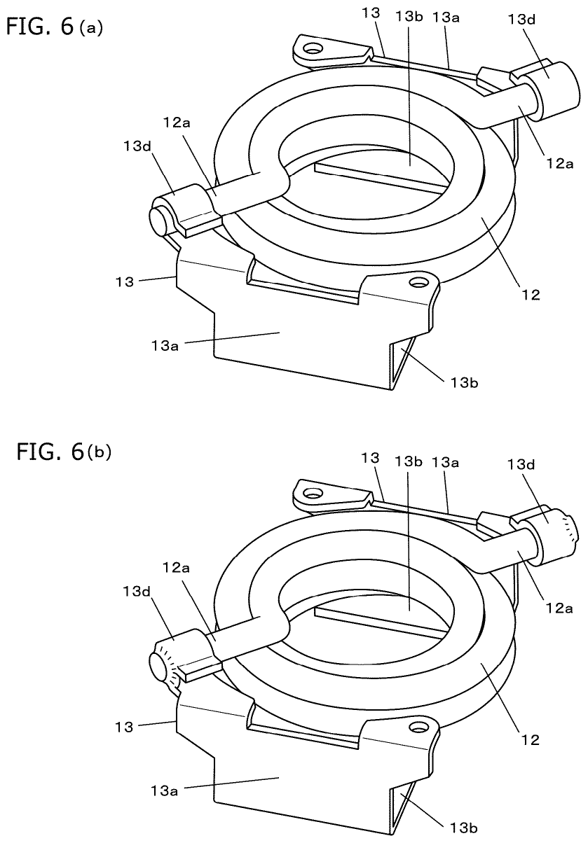

In FIG. 1, coil element end portions 12a are pulled out toward opposing end surfaces of the magnetic core, and crimped and fixed to crimp portions 13d of electrode members 13 while being inserted into crimp portions 13d of electrode members 13, respectively. However, configurations as shown in FIGS. 5 and 6 are also possible.

FIG. 5 is a transparent perspective view of an inductor according to another aspect of the embodiment of the present invention. FIG. 6 is a partial perspective view of the inductor shown in FIG. 5. In FIG. 6, (a) shows a state in which crimp portions 13d are crimped and fixed to coil element end portions 12a, respectively (a state before welding), and (b) shows a state in which crimp portions 13d are welded to coil element end portions 12a, respectively. In the inductor shown in FIG. 5, crimp portions 13d (portions of electrode members 13) that have been welded as shown in (b) in FIG. 6 are embedded in magnetic core 11.

In FIGS. 5 and 6, coil element end portions 12a are pulled out in directions toward diagonally opposite corners of magnetic core 11, respectively, when magnetic core 11 is viewed from above, and crimp portions 13d of electrode members 13 are crimped and fixed to coil element end portions 12a while being wound around coil element end portions 12a, respectively. As a result of coil element end portions 12a being pulled out in directions toward diagonally opposite corners of magnetic core 11 and connected to electrode members 13, respectively, as described above, it is possible to effectively use magnetic core 11 and improve superposition characteristics. Also, as a result of coil element end portions 12a being extended from the wound portion of the coil element toward the corners of magnetic core 11, coil element end portions 12a can be connected with a short distance, and DC resistance can be reduced.

Also, it is desirable that width w2 is smaller than width w1, where width w1 is the distance between opposing ends of a protruding portion of each electrode member 13 that protrudes from magnetic core 11, and width w2 is the width of a folded portion of electrode member 13 at magnetic core bottom surface 11b. As a result of with w2 that is the width of the folded portion of electrode member 13 at bottom surface 11b of magnetic core 11 being set to be smaller, the amount of solder used to mount the inductor on the mounting board can be reduced. Also, as a result of width w1 that is the distance between opposing ends of the protruding portion of electrode member 13 that protrudes from magnetic core 11 being set to be larger, the pull-out strength of electrode member 13 from the magnetic core can be improved.

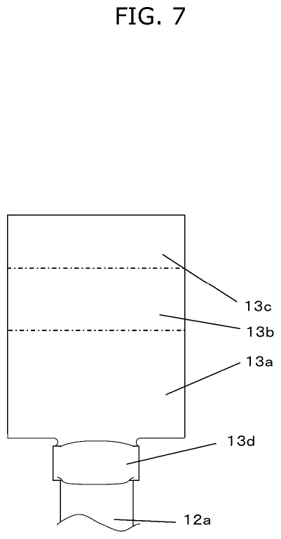

FIG. 7 is a diagram illustrating a part of a method for manufacturing an inductor according to another aspect of the embodiment of the present invention. FIG. 7 shows an example of a welded state of electrode member 13 and coil element end portion 12a different from the welded state shown in (c) in FIG. 4.

It is more desirable that, as shown in FIG. 7, a region of crimp portion 13d opposite to the leading end of coil element end portion 12a is also melted and solidified. Furthermore, crimp portion 13d and coil element end portion 12a crimped to crimp portion 13d may be completely melted to form a welding ball. With this configuration, coil element end portion 12a and electrode member 13 can be electromechanically connected in a more reliable manner. In addition, whether coil element end portion 12a and electrode member 13 are securely connected to each other can be checked from the outside.

By embedding the welded portion in magnetic core 11, electrode member 13 is rigidly fixed to magnetic core 11, and thus reliability can be improved. However, it is not possible to check the welded state after magnetic core 11 has been molded. For this reason, it is desirable to check the leading end of coil element end portion 12a through image recognition after crimping and after welding, and again check the leading end of coil element end portion 12a through image recognition after the welding step to check whether the leading end of the coil element has been melted and solidified. By doing so, before embedding the welded portion in magnetic core 11, it can be checked whether welding has been reliably performed, and when it is confirmed that welding has been reliably performed, the next step can be performed. Accordingly, reliability can be improved. As used herein, the expression “to check whether the leading end of the coil element has been melted and solidified” encompasses to check whether the corners of the leading end of the coil element before welding have been removed to form a rounded shape after welding, to check whether the color of the leading end of the coil element has changed before and after welding, and the like.

It is desirable that the leading end of coil element end portion 12a has a protrusion length protruding from crimp portion 13d of 0.05 mm or more, or a protrusion length protruding from crimp portion 13d that is equal to or less than two thirds of the length of crimp portion 13d. When the protrusion length is less than 0.05 mm, it is difficult to check the crimped leading end of coil element end portion 12a through image recognition. When the protrusion length is equal to or less than two thirds of the length of crimp portion 13d, heat is not sufficiently transferred to the leading end of coil element end portion 12a, and thus the leading end of the coil element is unlikely to be melted.

Next, the step of bending coil element end portion 12a and electrode member 13 is performed. This step is a preparation performed on coil element 12 and end surface portions 13a of electrode members 13 before placing the integrated body obtained by connecting coil element 12 and electrode members 13 in the cavity of a die used to pressure mold magnetic core 11, which will be described later.

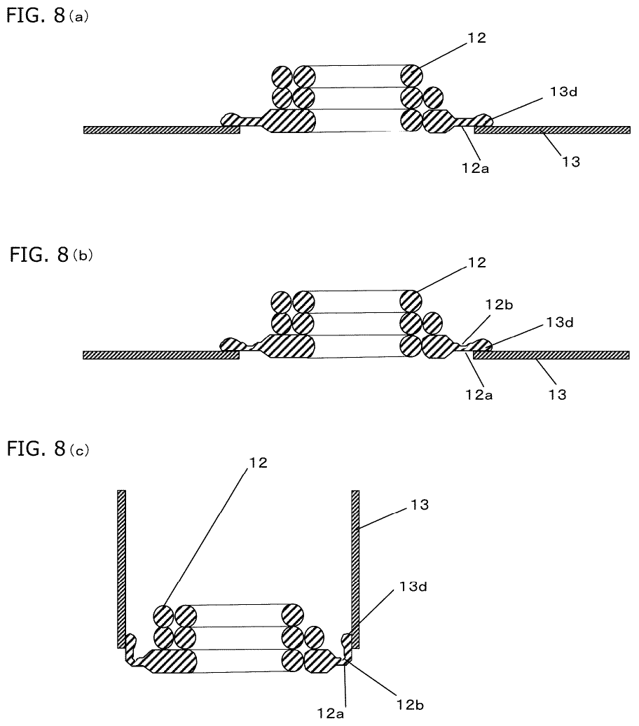

FIG. 8 is a diagram illustrating a part of the method for manufacturing an inductor according to the embodiment of the present invention.

First, notch 12b is formed in each coil element end portion 12a at a position between the wound portion of coil element 12 and the crimp portion. In FIG. 8, (a) shows a cross-sectional view of a state in which electrode member 13 has been welded to coil element end portion 12a. Next, as shown in (b) in FIG. 8, notch 12b is formed in coil element end portion 12a at a position between the wound portion of coil element 12 and the crimp portion using a die or the like. After that, coil element end portion 12a is bent at notch 12b that is a bending point. In this way, a state as shown in (c) in FIG. 8 is obtained.

When the folded portion moves in the embedded region in the magnetic core, the shape of the coil element is also likely to be deformed. As a result, electric characteristics such as inductance value are likely to vary. To address this, notch 12b is formed in coil element end portion 12a. With this configuration, coil element end portion 12a can be bent at notch 12b, and the shape of the coil element can be stabilized, as a result of which, the electric characteristics can be stabilized. In an ordinary inductor, a notch is provided to make coil element end portion 12a bendable. However, forming a notch is likely to deteriorate mechanical strength. In contrast, in the inductor according to the present embodiment, the bent portion bent at notch 12b is embedded in and fixed to magnetic core 11. Accordingly, even when notch 12b is formed, the mechanical strength can be maintained.

In the present embodiment, as the conductor wire, an insulated copper wire with a diameter of about 0.3 mm is used. Each end portion of the conductor wire is flattened into a flat shape with a thickness of about 0.2 mm. Notch 12b with a depth of about 0.1 mm is formed in the flattened portion. It is desirable that the depth of notch 12b is 40% or more and 70% or less of the thickness of coil element end portion 12a around notch 12b. When the depth of notch 12b is less than 40% of the thickness of coil element end portion 12a around notch 12b, the bent portion is unlikely to be stable. On the other hand, when the depth of notch 12b is greater than 70% of the thickness of coil element end portion 12a around notch 12b, the strength of notch 12b is likely to be weak during transportation or the like.

It is only necessary to form a notch before bending coil element end portion 12a, and the notch may be formed, for example, at the same time when the end portion of the coil element is flattened.

The shape of notch 12b as viewed in a cross section shown in (b) in FIG. 8 may be triangular, semicircular, trapezoidal, or the like. However, from the viewpoint of ease of bending coil element end portion 12a, it is more desirable to configure notch 12b to have a triangular shape as viewed in a cross section. In this case, it is desirable that the vertices of the triangular shape are rounded, and it is also desirable that the angle of each vertex is 90°±30°. When the angle of each vertex is too small, a problem is likely to occur in the service life of the die or the like. On the other hand, when the angle of each vertex is too large, the bending point is likely to vary.

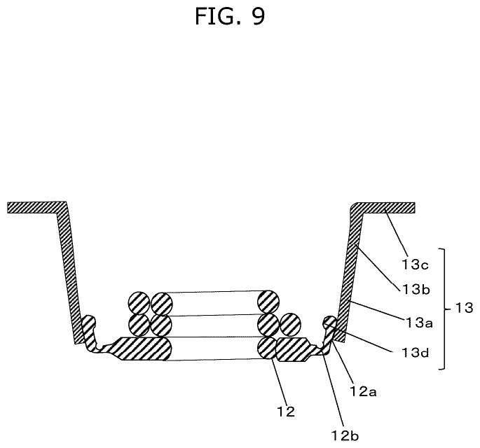

FIG. 9 is a diagram illustrating a part of the method for manufacturing an inductor according to the embodiment of the present invention.

The integrated body of coil element 12 and electrode members 13 is configured as shown in FIG. 9 before pressure molding magnetic core 11. Specifically, each coil element end portion 12a is bent at notch 12b, end surface portion 13a and bottom surface portion 13b are linearly formed, and support portion 13c is bent outward with respect to coil element 12.

In FIG. 8, coil element end portion 12a is bent after electrode member 13 has been fixed to coil element end portion 12a. However, in the case of the configuration as shown in FIGS. 5 and 6, each electrode member 13 may be folded into a predetermined shape, and then, crimp portion 13d of the electrode member may be crimped and fixed to coil element end portion 12a.

Meanwhile, a preparation for forming magnetic core 11 is performed. First, a magnetic compact powder is prepared by mixing a magnetic material powder made of an Fe—Si—Cr alloy and a binder made of a silicone. The magnetic compact powder is placed in a tablet die and compressed at a pressure of about 0.25 ton/cm² to form a magnetic powder tablet that is easily disintegrated by pressure. At this time, two magnetic powder tablets are made: a lower magnetic powder tablet for forming a lower portion of magnetic core 11; and an upper magnetic powder tablet for forming an upper portion of magnetic core 11. The lower magnetic powder tablet is configured to have recesses for housing coil element 12, and desirably has a pot shape that has an E-shaped cross section. Also, the upper magnetic powder tablet desirably has a flat plate shape such that it can close the recesses of the lower magnetic powder tablet.

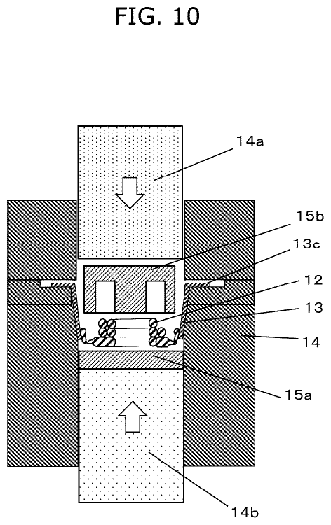

Next, pressure molding is performed. FIG. 10 is a diagram illustrating a part of the method for manufacturing an inductor according to the embodiment of the present invention, and schematically shows a state before pressure molding is performed in which upper magnetic powder tablet 15a, the integrated body of coil element 12 and electrode members 13, lower magnetic powder tablet 15b are placed in the cavity of die 14.

As shown in FIG. 10, upper magnetic powder tablet 15a is placed in die 14, the integrated body of coil element 12 and electrode members 13 is placed on upper magnetic powder tablet 15a, and lower magnetic powder tablet 15b is placed on the integrated body. Then, upper punch 14a is moved down, and lower punch 14b is moved up to perform pressure molding at a pressure of about 4 ton/cm². After the pressure molding, magnetic core 11 is formed in the cavity of die 14, with bottom surface portion 13b and support portion 13c of each electrode member 13 extending outward from magnetic core 11 (the cavity of die 14). At the time of pressure molding, coil element 12 can be positioned as a result of support portions 13c of electrode members 13 being placed on the die. As shown in FIG. 9, there may be a space above support portion 13c. With this configuration, it is possible to prevent the occurrence of a disconnection or the like caused by an excessive force being applied to the coil element or the electrode members during pressure molding.

As the method for placing lower magnetic powder tablet 15b in the die, lower magnetic powder tablet 15b may be placed after the integrated body of coil element 12 and electrode members 13 has been placed in the die. Alternatively, lower magnetic powder tablet 15b may be combined with the integrated body of coil element 12 and electrode members 13, and then placed in die 14.

By performing compact molding by placing the integrated body obtained by connecting coil element 12 and electrode members 13 in the cavity of the die as described above, the compact molding is performed, with end surface portion 13a of each electrode member 13 being in the cavity of the die, and at least a portion of electrode member 13 is embedded in and fixed to magnetic core 11 in the thickness of electrode member 13. On the other hand, bottom surface portion 13b of each electrode member 13 is not fixed to magnetic core 11 because bottom surface portion 13b is bent toward the bottom surface of magnetic core 11 after the compact molding has been performed, with bottom surface portion 13b extending outside of the cavity of the die. As described above, as a result of end surface portion 13a of each electrode member 13 being fixed to magnetic core 11, vibration resistance can be ensured. Also, because bottom surface portion 13b of each electrode member 13 is not fixed to magnetic core 11, heat cycle resistance can be improved.

As shown in FIG. 2, the surface of electrode member 13 at magnetic core end surface 11a without a plating layer faces magnetic core 11. On the other hand, plating layer 13f is formed on the surface of electrode member 13 opposite to the surface that faces magnetic core 11, and thus the inductor can be easily soldered to the mounting board. Also, no plating layer is provided on the surface of electrode member 13 that faces magnetic core 11, and thus even in a high temperature environment such as solder reflow, the bonding strength between magnetic core 11 and electrode member 13 can be maintained.

An inner wall of die 14 that forms end surface 11a of the magnetic core is configured such that an angle formed by a surface of upper punch 14a that forms magnetic core bottom surface 11b and a surface of the inner wall that abuts against end surface portion 13a of electrode member 13 is about 86.5°, and an angle formed by the surface of upper punch 14a that forms magnetic core bottom surface 11b and opposing sides of end surface portion 13a of electrode member 13 is about 89.5°. As described above, by changing the inclination angles of the inner wall surface of die 14 that abuts against end surface portion 13a of electrode member 13 and the surface that forms magnetic core end surface 11a′ on opposing sides of electrode member 13, even if entire magnetic core 11 expands when removing magnetic core 11 from the die after pressure molding, the inner wall of die 14 on end surface portions 13a of electrode members 13 functions as a support to restrict the expansion of surface 11c at the end surface portion of the electrode member. For this reason, electrode member 13 at magnetic core end surface 11a is unlikely to be damaged.

Furthermore, the position of end surface portion 13a of electrode member 13 is determined by die 14, and thus the shape is stabilized. Accordingly, when mounting and soldering the inductor, the soldering can be performed in a stable manner.

Also, the pressure molding may be performed by, when placing the integrated body of coil element 12 and electrode members 13 in die 14, deforming the integrated body to shorten the distance between end surface portions 13a of electrode members 13, after that, increasing the distance between end surface portions 13a of electrode members 13 to cause end surface portions 13a of electrode members 13 to abut against the inner wall of die 14, and placing lower magnetic powder tablet 15b. By doing so, when placing the integrated body of coil element 12 and electrode members 13 in die 14, it is possible to prevent end surface portions 13a of electrode members 13 from rubbing against the inner wall of die 14 and eventually from being damaged.

Magnetic core 11 obtained through the pressure molding is removed from die 14, and then thermally cured. Support portions 13c of electrode members 13 are cut, and bottom surface portions 13b of electrode members 13 are bent to obtain an inductor. As shown in FIG. 2, recesses are formed in magnetic core bottom surface 11b. Each electrode member 13 is provided such that end surface portion 13a abuts against magnetic core end surface 11a and electrode member 13 is bent such that a portion of bottom surface portion 13b is placed into the recess. Near the bending point of electrode member 13, a space is formed between bottom surface portion 13b and the recess. The end of bottom surface portion 13b abuts against the recess or is close to the recess, and bottom surface portion 13b is not embedded in magnetic core 11.

As a summary, an inductor according to the present embodiment and a method for manufacturing an inductor according to the present embodiment will be shown below.

### Example 1

An inductor including: a magnetic core including a bottom surface and an end surface connected to the bottom surface, the magnetic core being provided by pressure molding a mixture of a magnetic material powder and a binder; a coil element embedded in the magnetic core; and an electrode member electromechanically connected to an end portion of the coil element, wherein the electrode member is bent toward the bottom surface of the magnetic core from the end surface of the magnetic core, the electrode member includes a crimp portion, the electrode member and the end portion of the coil element being electromechanically connected by placing the end portion of the coil element on the electrode member, and crimping and welding the end portion of the coil element to the electrode member at the crimp portion, the crimp portion is embedded in the magnetic core, at least a portion of the electrode member at the end surface of the magnetic core is embedded in and fixed to the magnetic core in a thickness direction of the electrode member, and a portion of the electrode member at the bottom surface of the magnetic core is not fixed to the magnetic core.

### Example 2

The inductor according to example 1, wherein a notch is provided in the end portion of the coil element at a position between a wound portion of the coil element and the crimp portion, the end portion of the coil element is bent at the notch, and the crimp portion and the notch are embedded in the magnetic core.

### Example 3

The inductor according to example 1 or 2, wherein an angle formed by the bottom surface of the magnetic core and the end surface of the magnetic core on opposing sides of the electrode member is greater than an angle formed by the bottom surface of the magnetic core and a surface of the electrode member at the end surface of the magnetic core, and the angle formed by the bottom surface of the magnetic core and the end surface of the magnetic core on the opposing sides of the electrode member is less than 90.0°.

### Example 4

The inductor according to example 3, wherein an angle formed by the end surface of the magnetic core on the opposing sides of the electrode member and the surface of the electrode member at the end surface of the magnetic core is 2.0° or more and 5.0° or less.

### Example 5

The inductor according to example 1 or 2, wherein no plating layer is provided on a surface of the electrode member that faces the magnetic core, and a plating layer is provided on a surface of the electrode member that does not face the magnetic core.

### Example 6

A method for manufacturing an inductor in which a coil element is embedded in a magnetic core including a bottom surface and an end surface connected to the bottom surface, and end portions of the coil element are electromechanically connected to electrode members, the method including: forming the coil element by spirally winding a conductor wire whose surface is covered with an insulation covering, pulling out opposing ends of the conductor wire in opposite directions, and stripping the insulation covering at the opposing ends of the conductor wire; providing the electrode members each including a crimp portion, an end surface portion, a bottom surface portion, and a support portion; crimping the end portions of the coil element to the electrode members at the crimp portions by placing the end portions of the coil elements on the electrode members, respectively, to fix the end portions of the coil element to the electrode members; welding the coil element and the electrode members together to form an integrated body of the coil element and the electrode members by irradiating the crimp portions with laser light; bending the end portions of the coil element or the electrode members; obtaining an upper magnetic powder tablet and a lower magnetic powder tablet by molding a mixture of a magnetic material powder and a resin; forming the magnetic core by pressure molding the upper magnetic powder tablet, the integrated body of the coil element and the electrode members, and the lower magnetic powder tablet that have been placed in a die in stated order; and forming an electrode by cutting off the support portion of each of the electrode members and folding the bottom surface portion of the electrode member, wherein the crimp portions are embedded in the magnetic core, at least a portion of each of the electrode members at the end surface of the magnetic core is embedded in and fixed to the magnetic core in a thickness direction of the electrode member, and a portion of each of the electrode members at the bottom surface of the magnetic core is not fixed to the magnetic core.

### Example 7

The method for manufacturing an inductor according to example 6, further including: forming a notch in each of the end portions of the coil element at a position between a wound portion of the coil element and the crimp portion, wherein the crimp portion and the notch are embedded in the magnetic core.

### Example 8

The method for manufacturing an inductor according to example 7, wherein the notch has a depth that is 40% or more and 70% or less of a thickness of the end portion of the coil element around the notch.

### Example 9

The method for manufacturing an inductor according to example 7 or 8, further including: prior to the bending of the end portions of the coil element or the electrode members, forming a notch at a bending portion of each of the end portions of the coil element, wherein the notch is embedded in the magnetic core.

### Example 10

The method for manufacturing an inductor according to example 6 or 7, wherein a portion of an inner surface of the die that abuts against the end surface portion of each of the electrode members and each side of the die are inclined at different angles to cause an angle formed by the bottom surface of the magnetic core and the end surface of the magnetic core on opposing sides of the electrode member to be greater than an angle formed by the bottom surface of the magnetic core and a surface of the electrode member at the end surface of the magnetic core, and the angle formed by the bottom surface of the magnetic core and the end surface of the magnetic core on the opposing sides of the electrode member is less than 90.0°.

### Example 11

The method for manufacturing an inductor according to example 6 or 7, wherein an angle formed by the end surface of the magnetic core on the opposing sides of the electrode member and the surface of the electrode member at the end surface of the magnetic core is 2.0° or more and 5.0° or less.

### Example 12

The method for manufacturing an inductor according to example 6 or 7, wherein the crimping is performed, with leading ends of the end portions of the coil element protruding from the crimp portions, the welding is performed by irradiating the crimp portions with laser light, and after the welding, the leading ends of the end portions of the coil element are melted and solidified.

### Example 13

The method for manufacturing an inductor according to example 6 or 7, wherein a portion of the crimp portion opposite to a leading end of each of the end portions of the coil element is melted and solidified.

### Example 14

The method for manufacturing an inductor according to example 6 or 7, wherein, after the crimping and the welding, leading ends of the end portions of the coil element are subjected to image recognition, and after the welding, the leading ends of the end portions of the coil element are again subjected to image recognition to check whether the leading ends of the end portions of the coil element have been melted and solidified.

### Example 15

The method for manufacturing an inductor according to example 6 or 7, wherein, in the forming of the magnetic core, when placing the integrated body of the coil element and the electrode members in the die, the integrated body of the coil element and the electrode members is deformed to shorten a distance between the end surface portions of the electrode members, and placed in the die, after which, the distance between the end surface portions of the electrode members is increased to cause the end surface portions of the electrode members to abut against an inner wall of the die, and the pressure molding is performed.

Other possible implementations of the inductor according to the present embodiment will be shown below.

### Example 16

An inductor including: a magnetic core including a bottom surface and an end surface connected to the bottom surface, the magnetic core being provided by pressure molding a mixture of a magnetic material powder and a binder; a coil element embedded in the magnetic core; and an electrode member electromechanically connected to an end portion of the coil element, wherein the electrode member is bent toward the bottom surface of the magnetic core from the end surface of the magnetic core, the electrode member includes a crimp portion, the electrode member and the end portion of the coil element being electromechanically connected by placing the end portion of the coil element on the electrode member, and crimping and welding the end portion of the coil element to the electrode member at the crimp portion, the crimp portion is embedded in the magnetic core, an angle formed by the bottom surface of the magnetic core and the end surface of the magnetic core on opposing sides of the electrode member is greater than an angle formed by the bottom surface of the magnetic core and a surface of the electrode member at the end surface of the magnetic core, and the angle formed by the bottom surface of the magnetic core and the end surface of the magnetic core on the opposing sides of the electrode member is less than 90.0°.

### Example 17

An inductor including: a magnetic core including a bottom surface and an end surface connected to the bottom surface, the magnetic core being provided by pressure molding a mixture of a magnetic material powder and a binder; a coil element embedded in the magnetic core; and an electrode member electromechanically connected to an end portion of the coil element, wherein the electrode member is bent toward the bottom surface of the magnetic core from the end surface of the magnetic core, the electrode member includes a crimp portion, the electrode member and the end portion of the coil element being electromechanically connected by placing the end portion of the coil element on the electrode member, and crimping and welding the end portion of the coil element to the electrode member at the crimp portion, a notch is provided in the end portion of the coil element at a position between a wound portion of the coil element and the crimp portion, the end portion of the coil element is bent at the notch, the crimp portion and the notch are embedded in the magnetic core, at least a portion of the electrode member at the end surface of the magnetic core is embedded in and fixed to the magnetic core in a thickness direction of the electrode member, and a portion of the electrode member at the bottom surface of the magnetic core is not fixed to the magnetic core.

### INDUSTRIAL APPLICABILITY

With the inductor and the method for manufacturing an inductor according to the present invention, an inductor that has excellent vibration resistance and excellent heat cycle resistance can be obtained. Accordingly, the inductor and the method for manufacturing an inductor according to the present invention are industrially useful.

### REFERENCE SIGNS LIST

11 magnetic core

11a magnetic core end surface

11a′ magnetic core end surface on opposing sides of electrode member

11b magnetic core bottom surface

11c surface at end surface portion of electrode member

12 coil element

12a coil element end portion

12b notch

13 electrode member

13a end surface portion

13b bottom surface portion

13c support portion

13d crimp portion

13f plating layer

14 die

14a upper punch

14b lower punch

15a upper magnetic powder tablet

15b lower magnetic powder tablet

16 laser light irradiation position

w1, w2 width

1. An inductor comprising:
a magnetic core including a bottom surface and an end surface connected to the bottom surface, the magnetic core being provided by pressure molding a mixture of a magnetic material powder and a binder;
a coil element embedded in the magnetic core; and
an electrode member electromechanically connected to an end portion of the coil element,
wherein the electrode member is bent toward the bottom surface of the magnetic core from the end surface of the magnetic core,
the electrode member includes a crimp portion, the electrode member and the end portion of the coil element being electromechanically connected by placing the end portion of the coil element on the electrode member, and crimping and welding the end portion of the coil element to the electrode member at the crimp portion,
the crimp portion is embedded in the magnetic core,
at least a portion of the electrode member at the end surface of the magnetic core is embedded in and fixed to the magnetic core in a thickness direction of the electrode member, and
a portion of the electrode member at the bottom surface of the magnetic core is not fixed to the magnetic core.

2. The inductor according to claim 1,
wherein a notch is provided in the end portion of the coil element at a position between a wound portion of the coil element and the crimp portion,
the end portion of the coil element is bent at the notch, and
the crimp portion and the notch are embedded in the magnetic core.

3. The inductor according to claim 1,
wherein an angle formed by the bottom surface of the magnetic core and the end surface of the magnetic core on opposing sides of the electrode member is greater than an angle formed by the bottom surface of the magnetic core and a surface of the electrode member at the end surface of the magnetic core, and
the angle formed by the bottom surface of the magnetic core and the end surface of the magnetic core on the opposing sides of the electrode member is less than 90.0°.

4. The inductor according to claim 3,
wherein an angle formed by the end surface of the magnetic core on the opposing sides of the electrode member and the surface of the electrode member at the end surface of the magnetic core is 2.0° or more and 5.0° or less.

5. The inductor according to claim 1,
wherein no plating layer is provided on a surface of the electrode member that faces the magnetic core, and
a plating layer is provided on a surface of the electrode member that does not face the magnetic core.

6. A method for manufacturing an inductor in which a coil element is embedded in a magnetic core including a bottom surface and an end surface connected to the bottom surface, and end portions of the coil element are electromechanically connected to electrode members, the method comprising:
forming the coil element by spirally winding a conductor wire whose surface is covered with an insulation covering, pulling out opposing ends of the conductor wire in opposite directions, and stripping the insulation covering at the opposing ends of the conductor wire;
providing the electrode members each including a crimp portion, an end surface portion, a bottom surface portion, and a support portion;
crimping the end portions of the coil element to the electrode members at the crimp portions by placing the end portions of the coil elements on the electrode members, respectively, to fix the end portions of the coil element to the electrode members;
welding the coil element and the electrode members together to form an integrated body of the coil element and the electrode members by irradiating the crimp portions with laser light;
bending the end portions of the coil element or the electrode members;
obtaining an upper magnetic powder tablet and a lower magnetic powder tablet by molding a mixture of a magnetic material powder and a resin;
forming the magnetic core by pressure molding the upper magnetic powder tablet, the integrated body of the coil element and the electrode members, and the lower magnetic powder tablet that have been placed in a die in stated order; and
forming an electrode by cutting off the support portion of each of the electrode members and folding the bottom surface portion of the electrode member,
wherein the crimp portions are embedded in the magnetic core,
at least a portion of each of the electrode members at the end surface of the magnetic core is embedded in and fixed to the magnetic core in a thickness direction of the electrode member, and
a portion of each of the electrode members at the bottom surface of the magnetic core is not fixed to the magnetic core.

7. The method for manufacturing the inductor according to claim 6, further comprising:
forming a notch in each of the end portions of the coil element at a position between a wound portion of the coil element and the crimp portion,
wherein the crimp portion and the notch are embedded in the magnetic core.

8. The method for manufacturing the inductor according to claim 7,
wherein the notch has a depth that is 40% or more and 70% or less of a thickness of the end portion of the coil element around the notch.

9. The method for manufacturing the inductor according to claim 7, further comprising:
prior to the bending of the end portions of the coil element or the electrode members, forming a notch at a bending portion of each of the end portions of the coil element,
wherein the notch is embedded in the magnetic core.

10. The method for manufacturing the inductor according to claim 6,
wherein a portion of an inner surface of the die that abuts against the end surface portion of each of the electrode members and each side of the die are inclined at different angles to cause an angle formed by the bottom surface of the magnetic core and the end surface of the magnetic core on opposing sides of the electrode member to be greater than an angle formed by the bottom surface of the magnetic core and a surface of the electrode member at the end surface of the magnetic core, and
the angle formed by the bottom surface of the magnetic core and the end surface of the magnetic core on the opposing sides of the electrode member is less than 90.0°.

11. The method for manufacturing the inductor according to claim 6,
wherein an angle formed by the end surface of the magnetic core on the opposing sides of the electrode member and the surface of the electrode member at the end surface of the magnetic core is 2.0° or more and 5.0° or less.

12. The method for manufacturing the inductor according to claim 6,
wherein the crimping is performed, with leading ends of the end portions of the coil element protruding from the crimp portions,
the welding is performed by irradiating the crimp portions with laser light, and
after the welding, the leading ends of the end portions of the coil element are melted and solidified.

13. The method for manufacturing the inductor according to claim 6,
wherein a portion of the crimp portion opposite to a leading end of each of the end portions of the coil element is melted and solidified.

14. The method for manufacturing the inductor according to claim 6,
wherein, after the crimping and the welding, leading ends of the end portions of the coil element are subjected to image recognition, and
after the welding, the leading ends of the end portions of the coil element are again subjected to image recognition to check whether the leading ends of the end portions of the coil element have been melted and solidified.

15. The method for manufacturing the inductor according to claim 6,
wherein, in the forming of the magnetic core, when placing the integrated body of the coil element and the electrode members in the die, the integrated body of the coil element and the electrode members is deformed to shorten a distance between the end surface portions of the electrode members, and placed in the die, after which, the distance between the end surface portions of the electrode members is increased to cause the end surface portions of the electrode members to abut against an inner wall of the die, and the pressure molding is performed.
